(19) United States
(12) Patent Application Publication
(10) Pub. No.: US 2022/0235889 A1
(43) Pub. Date: Jul. 28, 2022

(54) HOSE CONNECTOR, HOSE LINE, AND METHOD FOR PRODUCING A HOSE CONNECTOR

(71) Applicant: Neoperl GmbH, Mullheim (DE)

(72) Inventor: Holger REINHARDT, March/Buchheim (DE)

(73) Assignee: Neoperl GmbH, Mullheim (DE)

(21) Appl. No.: 17/612,599

(22) PCT Filed: Mar. 13, 2020
(86) PCT No.: PCT/EP2020/056997

§ 371 Date: Nov. 19, 2021

(30) Foreign Application Priority Data
May 20, 2019 (DE) 20 2019 102 837.8

(51) Int. Cl. F16L 33/213; F16L 33/01

(52) U.S. Cl. CPC F16L 33/213; F16L 33/01

(57) ABSTRACT

A hose connector (5) which can be fixed to the hose end region of a flexible hose (6) and includes an outer part (7), which surrounds the hose end region, and an inner part (8), which can be inserted into the clear cross section of the hose. The inner part (8) is in the form of a hollow rivet and is deformable between an initial form, which can be inserted into the clear cross section of the hose at the hose end region, and a widened form, which sealingly and fixedly clamps the at least one hose between the inner part (8) and the outer part (7). A hose line that can also be formed for example as a two-chamber or multi-chamber hose line is provided. Moreover, a method for producing a hose connector on the hose end region of a flexible hose is provided.

### TECHNICAL FIELD

The invention relates to a hose connector which can be fixed on the hose end region of at least one flexible hose and which, to this end, has an outer part which engages around the hose end region of the at least one hose and an inner part which can be introduced into the inside hose cross section.

The invention is also concerned with a hose line which has a hose connector of the abovementioned type at at least one line end. Moreover, the invention is concerned with a hose line which is configured as a two-chamber or multiple-chamber hose line and has an outer hose, the inside hose cross section of which is penetrated by at least one inner hose, the outer hose being assigned at least one hose coupling with a hose nipple, which hose nipple engages tightly around an associated hose end region of the outer hose.

Moreover, the invention also provides a method for producing a hose connector, in particular of the abovementioned type, at the hose end region of a flexible hose, which hose connector has an outer part, which engages around the hose in a hose end region, and an inner part.

### BACKGROUND

In order for it to be possible for washbasins, hand showers, dishwashers, washing machines or other water consumption points to be connected to the water supply network, flexible hose lines are increasingly being used which are connected at one line end to an angle valve and at their other line end to the water consumption point.

Said hose lines as a rule have a hose made from flexible material with a hose connector which is fixed on at least one of the hose end regions of the flexible hose (cf. FIG. 30 of the present IP application). Said hose connector has an inner part which can be introduced into the inside hose cross section, is configured as a sleeve-shaped dimensionally stable cast or turned part, and has a holding profile comprising a plurality of holding grooves on the outer circumferential side in its part region which is pushed into the hose interior. The hose end region which is pushed onto the inner part is fixed with the aid of an outer part which is configured as a crimp sleeve which can be crimped and, in the crimped estate, clamps the hose end region between itself and the inner part. An annular flange can be provided on that part region of the inner part which projects beyond the hose end region, which annular flange serves as a sliding stop for a union nut which engages around the hose connector and secures said union nut on the inner part. In order for it to be possible for the inner part to be pushed into the hose end region, the inner part has to have, at its inner part end, an insertion cone which requires a reduced diameter of the inner part in comparison with the inside hose diameter. As a result, however, the inner part projects on the inner circumference of the hose and reduces the free line cross section in said line section. Moreover, the production of the inner part as a turned or cast part and the crimping of the outer part which is configured as a crimp sleeve are associated with a not inconsiderable complexity. The construction and production complexity for hose lines of this type is also additionally increased if hose lines of this type are configured as two-chamber or multiple-chamber hose lines which have two or more chambers which serve as liquid guides which are separate from one another.

### SUMMARY

There is therefore the object to provide a hose connector and a hose line of the type mentioned at the outset, and a method for producing a hose connector of this type, which are associated with production complexity which is reduced in contrast.

In the case of the hose connector of the type mentioned at the outset, said object is achieved according to the invention, in particular, in that the inner part is configured as a hollow rivet and can be deformed between a starting shape, which can be introduced into the inside hose cross section of the hose end region, and a widened shape which clamps the at least one hose in a tight and fixing manner between the inner part and the outer part.

The hose connector according to the invention can be fixed on the hose end region of a flexible hose. Said hose has a hose connector of this type on at least one of its hose end regions. To this end, the hose connector according to the invention has an outer part, which engages around the associated hose end region, and an inner part which can be introduced into the inside hose cross section. According to the invention, said inner part is configured as a hollow rivet. The hollow rivet which can be introduced into the inside hose cross section on the hose end region and serves as an inner part of the hose connector can be deformed between a starting shape and a widened shape, in which widened shape the hollow rivet clamps the hose in a tight and fixing manner in its hose end region between itself and the outer part. Since the hollow rivet which is introduced into the inside hose cross section in its starting shape is widened, axial forces do not act here on the constituent parts of the hose connector, and a fixed connection of the hose and of the hose connector is ensured. Since the hollow rivet which serves as an inner part is widened for fixing the hose end region on the hose connector, an undesired (since disadvantageous) reduction of the inside hose cross section in this hose end region is avoided, and a sufficient throughflow through the hose line continues to be ensured even in the region of its at least one hose connector. The hose connector according to the invention can be mounted securely and rapidly, and can be fixed exactly at the desired position of the hose. Since the mounting of the hose connector according to the invention on the associated hose end region of a hose line is of simple design, the mounting of the hose connector on the hose end region is possible with little complexity. By way of the joining technology which is used, a disadvantageous reduction of the hose internal diameter in the region of the hose connector is avoided. Since the hose connector can also consist only of the outer part and the deformable inner part, a reduction of the required constituent parts is possible. Said constituent parts of the hose connector according to the invention, namely the outer part and the inner part, can be fixed securely and fixedly on the hose end region of a flexible hose by way of simple aids. Here, the mounting of the hose connector according to the invention is possible in a satisfactorily reproducible method.

One embodiment according to the invention which is particularly simple and easy to mount provides that the inner part is configured as a plunge rivet.

It is conceivable that the inner part is configured as a collar-less hollow rivet which is cylindrical on its outer circumference.

In order to facilitate the positionally accurate mounting of the inner part and the outer part and of the hose end region which is clamped in between, it is advantageous, however, if, at its end side which projects beyond the hose end region, the inner part supports a radially outwardly projecting annular flange. Therefore, the inner part which is configured as a hollow rivet can be introduced in its non-deformed starting shape into the inside hose cross section on the hose end region of the flexible hose, until the annular flange bears against the adjacent end side of the hose.

In order that the hose connector according to the invention can be connected securely and tightly to a fluid line, it is advantageous if the annular flange of the inner part tapers toward its outer edge, and/or if the annular flange has a preferably convexly curved shape on its end side which faces away from the hose end region.

The positionally accurate mounting of the inner part on the outer part of the hose cross section according to the invention is aided further if the inner part can be introduced into the inside hose cross section until the annular flange bears against the adjacent end face of the outer part. Since, in the mounted position of the hose connector, the annular flange which is provided on the inner part bears against the adjacent end face of the outer part, and since the annular flange is therefore additionally supported in its outer annular zone by way of the outer part, the hose connector according to the invention is also distinguished in this region by a high stability.

The introduction of the inner part into the inside hose cross section of the hose is aided, and controlled deformation of the inner part during the widening is facilitated if, in a sleeve-shaped part region, the inner part has a wall thickness which increases in the direction toward that end face of the inner part which faces away from the hose end region and, in particular, toward its annular flange.

In order that the hose end region is held securely and fixedly between the outer part and the widened inner part, it is advantageous if, on its sleeve-shaped part region, the hollow rivet has a retaining profiling on the outer circumferential side.

One simple and advantageous embodiment according to the invention provides that said retaining profiling has at least one circumferential retaining groove.

The object set above is achieved according to the invention in the case of the hose line of the type mentioned at the outset, in particular, in that the annular flange of the inner part projects beyond the outer circumference of the outer part, in that the outer part is engaged around by a union nut, in that the inner part secures the union nut on the outer part, and in that, to this end, that annular zone of the annular flange which projects beyond the outer circumference of the outer part serves as a sliding stop for the union nut which is retained on the outer part.

The hose line which is configured in accordance with this embodiment of the invention has a hose connector which can be fixed on an associated hose end region of a flexible hose. To this end, said hose connector has an outer part, which engages around the associated hose end region of the hose, and an inner part which can be introduced into the inside hose cross section. Here, the inner part is configured as a hollow rivet which can be deformed between a starting shape, in which it can be introduced into the inside hose cross section of the hose end region, and a widened shape, in which it clamps the at least one hose in a tight and fixing manner between the inner part and the outer part. On its end face which projects beyond the hose end region, the inner part has an annular flange which projects radially outwardly beyond the outer circumference of the outer part. The outer part is engaged around by a union nut which is secured on the outer part by the inner part and the annular flange which projects on it. Here, that annular zone of the annular flange which projects beyond the outer circumference of the outer part serves as a sliding stop for the union nut which is preferably held rotatably on the outer part. The hose line which is configured in accordance with this proposal of the invention therefore has a hose connector which can be produced with little complexity, is easy to mount, and can replace conventional hose fittings with inner parts which are configured as a turned or cast part.

One particularly advantageous embodiment according to the invention provides that the outer part is configured as a supporting sleeve.

The low production complexity is additionally facilitated if the annular flange is configured as a rim on the inner part.

The production of the hose line according to the invention is additionally simplified if the hose is produced from a resiliently flexible material and, in particular, from a resiliently flexible plastic material. The hose which is used for the hose line according to the invention can also have a braid. Said braid can consist of any suitable material. It is therefore also possible, for example, that the braid is configured as a plastic braid or as a metal braid.

If the provided applications require it, the hose which is used for the hose line according to the invention can also be configured as a wound braid hose and, in particular, as a double-interlocked hose.

The high load-bearing capacity and tightness of the hose line according to the invention is also aided if the wound braid hose or the braided hose has at least one hose layer which encases it tightly, and/or if the wound braid hose or the braid encases at least one inner hose.

The fixed connection even of a multiple-layer hose and of the at least one hose connector which is provided on at least one of its hose end regions is aided if the inner part clamps the wound braid hose or the braiding on one side and the encasing hose layer or the at least one inner hose on the other side in a tight and fixing manner between itself and the outer part.

In the case of a hose line which is configured as a two-chamber or multiple-chamber hose line, the object set above is achieved according to the invention in that the hose coupling has an end-side receiving cavity, in which a hose connector is provided for the at least one inner hose, which hose connector has an outer part which can be inserted into the receiving cavity of the hose coupling, in which outer part at least two holes which penetrate the outer part are provided, of which the outer part engages around a hose end region of the at least one inner hose at least in one hole, and in that an inner part of the hose connector projects into the hose end region of the at least one inner hose, which inner part is widened in such a way that the inner hose is clamped in a tight and fixing manner between the inner part, which projects into said inner hose, and the outer part.

The hose line which is configured in accordance with this embodiment of the invention is designed as a two-chamber or multiple-chamber hose line, in which two or more than two fluid guides are routed separately from one another. To this end, the hose line according to the invention in accordance with this proposal of the invention has an outer hose, the inside hose cross section of which is penetrated by at least one inner hose. The outer hose is assigned at least one hose coupling with a hose nipple, which hose nipple engages around an associated hose end region of the outer hose tightly. The hose coupling which is provided on at least one of the two hose end regions of the hose line has an end-side receiving cavity, in which a hose connector for the at least one inner hose is provided. Said hose connector has an outer part which can be inserted into the receiving cavity of the hose coupling which is assigned to the outer hose. At least two holes which penetrate the outer part are provided in the outer part of the hose connector, of which the outer part engages around a hose end region of the at least one inner hose at least in one hole. An inner part of the hose connector projects into the hose end region of the at least one inner hose, the inner part being widened in such a way that the inner hose is clamped in a tight and fixing manner between the inner part, which projects into said hose, and the outer part. Here, each of the fluid guides which are provided in the hose line according to the invention can be assigned in each case one inner hose. It is also possible, however, for at least one inner hose to be used as a fluid guide, in order, moreover, for the hose lumen which is provided between said at least one inner hose and the outer hose to be provided as a further separate fluid guide. The hose line according to the invention can be produced and mounted with low complexity, although said hose line is passed through by at least two fluid guides separately from one another.

In order for the hose lumen, which remains between the at least one inner hose and the outer hose, of the outer hose to also be able to be used as an independent fluid guide, it is advantageous if at least one of the holes in the outer part of the hose connector opens into that hose cavity of the outer hose which is enclosed between the inner circumference of the outer hose and the outer circumference of the at least one inner hose. Therefore, no further separate inner hose is held on the relevant hole in the outer part.

In contrast, another embodiment of the hose line according to the invention provides that the hose end region of in each case one inner hose is retained in a tight and fixing manner in each of the holes in the outer part of the hose connector. In the case of this exemplary embodiment of the hose line according to the invention, each of the fluid guides which are separate from one another is assigned in each case one inner hose, whereas, in contrast, the outer hose forms merely a further protective cover for the inner hoses which are routed in its hose interior.

In order for it to be possible for the different fluid guides to be coupled possibly even in different planes of the hose coupling, it is advantageous if the outer part has a pot-shaped part region which can be inserted into the receiving cavity of the hose coupling, and if a sleeve-shaped part region of reduced cross section projects on the pot bottom of said pot shape, into which sleeve-shaped part region of the outer part the hose end region of the inner hose is clamped in a tight and fixing manner by means of the inner part of the hose connector.

In order for it to be possible for the outer part which is provided as line connector of the inner hose to be sealed satisfactorily in the region of the hose coupling, it is expedient if, at least on its projecting sleeve-shaped part region, the outer part has at least one annular groove for an annular seal. In addition or instead, it can be advantageous if an axial seal or a shaped seal is provided on the outer part, possibly also in the embodiment of what is known as a two-hole seal.

In the case of the method mentioned at the outset, the object set above is achieved according to the invention in that the inner part is inserted, in a first method step, into that hose end region of the hose which is engaged around by the outer part, and in that the hollow rivet serving as inner part is widened, in at least one second following method step, in such a way that the hose is clamped in an immovable and tight manner between the inner part and the outer part.

Here, a rivet pin or an expanding mandrel which is possibly also in multiple pieces can be used to widen the inner part which is configured as a hollow rivet.

In order for it to be possible for the hollow rivet which is provided as an inner part of the hose connector to also be widened to a greater external diameter at least in regions, it can be expedient if the hollow rivet which serves as an inner part is widened in a plurality of method steps which follow one another in order to clamp the hose between it and the outer part, and if, for the method steps which follow one another, stepped rivet pins or at least one stepped widening mandrel with different widening diameters are/is preferably used. Here, a further embodiment according to the invention provides that a plurality of unstepped or stepped widening mandrels with different widening diameters are used.

One preferred exemplary embodiment according to the invention provides that the inner part has a widened cross-sectional portion in its inside diameter in the region of the annular flange, which widened cross-sectional portion is preferably of open configuration toward that end side of the inner part which supports the annular flange. Since the inner part is additionally reinforced and stiffened, in the region of its end face which supports the annular flange, by way of the annular flange which projects on the outer circumference of the inner part, unintentional tearing off of the rivet pin in the region of its rivet head which supports the widening diameter is avoided if the inner part has a widened cross-sectional portion there in its inside diameter. Here, one embodiment is preferred, in the case of which the widened cross-sectional portion is of open configuration toward that end side of the inner part which supports the annular flange, and does not have another narrowed cross-sectional portion.

### BRIEF DESCRIPTION OF THE DRAWINGS

Developments according to the invention result from the following description of the figures including the drawing and the claims In the following text, the invention will be described in even greater detail on the basis of a plurality of preferred exemplary embodiments.

In the drawings:

FIG. 1 shows a hose line which is configured as a two-chamber hose line and has an outer hose, the inside hose cross section of which is penetrated by an inner hose, the outer hose being assigned a hose coupling with a hose nipple, around which a hose end region of the outer hose engages in a tight manner, and the hose coupling having an end-side receiving cavity, into which the outer part of a hose connector is inserted, which outer part has a sleeve-shaped part region of reduced cross section, by way of which the outer part engages around an inner hose, and an inner part which is configured as a hollow rivet being provided in order to fix the inner hose in the sleeve-shaped part region of the outer part, which inner part can be introduced into the inside hose cross section of the inner hose, in order, after widening of the inner part which is configured as a hollow rivet, to clamp the inner hose between itself and the outer part,

FIG. 2 shows the inner part which is configured as a hollow rivet immediately before the introduction into the inside hose cross section of the inner hose of the hose line which is shown in FIG. 1, the sleeve-shaped inner part being seated on a rivet pin which is provided for widening the hollow rivet, and said constituent parts of the hose line being shown in that part region of the hose line which has a rectangular border in FIG. 1,

FIG. 3 shows the hose line from FIGS. 1 and 2 in a further production step, in the case of which the inner part which is seated on the rivet pin has already been inserted into that hose end region of the inner hose which is engaged around by the outer part,

FIG. 4 shows the projecting sleeve-shaped part region of reduced cross section of the outer part, which outer part engages between itself and the inner part around the hose end region of the inner hose, the inner part which is seated on the conically widened widening head of the rivet pin being inserted into the hose end region of the inner hose, and said constituent parts of the hose line from FIGS. 1 to 3 being shown in the part region which has a rectangular border in FIG. 3,

FIG. 5 shows the hose line from FIGS. 1 to 4 during pulling of the rivet pin through the inner part which is configured as a hollow rivet,

FIG. 6 shows the outer part, the inner part and that hose end region of the inner hose which is clamped between them, in a partial longitudinal section through the part region which has a rectangular border in FIG. 5,

FIG. 7 shows the hose line (likewise partially longitudinally sectioned here) from FIGS. 1 to 6 after pulling through of the rivet pin which is now exposed through the inner part which is configured as a hollow rivet, the inner part being shown here in its widened widening shape, in which widening shape the inner part clamps the hose end region of the inner hose in a tight and fixing manner between itself and the outer part,

FIG. 8 shows the hose connector of the inner hose of the hose line which is shown in FIGS. 1 to 7, immediately after pulling through of the rivet pin, the outer part, the inner part and the hose end region which is clamped in between being shown here in the partial longitudinal section which has a rectangular border in FIG. 7,

FIG. 9 shows the hose line which is produced in the method steps according to FIGS. 1 to 8, is shown here then in the finished state, and the outer hose of which is penetrated by the inner hose, the inner hose on one side and the hose lumen of the outer sleeve, which hose lumen remains between the inner hose and the outer hose, forming two fluid guides which are separate from one another,

FIG. 10 shows the hose line from FIGS. 1 to 9 in the longitudinally sectioned part region which has a rectangular border in FIG. 9,

FIG. 11 shows the constituent parts of the hose line which is shown in FIGS. 1 to 10 in the region of the one hose end of its outer hose, together with the rivet pin which is required for widening of the inner part which is configured as a plunge rivet, in an exploded perspective illustration of the individual components,

FIG. 12 shows a multiple-chamber hose line in a longitudinal section, three fluid guides which are separate from one another passing through the outer hose of the hose line, of which fluid guides two fluid guides are formed by way of inner hoses which are routed in the hose interior of the outer hose,

FIG. 13 shows the hose line from FIG. 12 in a perspective illustration of that end region of its outer hose which has a hose coupling,

FIG. 14 shows a wound braid hose or double-interlocked hose in a partial longitudinal section, a hose connector being mounted on the hose end region of said wound braid hose or double-interlocked hose in a first production step, and, to this end, an outer part of the hose connector encasing the wound braid hose or double-interlocked hose, into which outer part an inner part which is configured as a hollow rivet and can be widened by means of a rivet pin can be inserted,

FIG. 15 shows that hose end region of the wound braid hose or double-interlocked hose which is engaged around by the sleeve-shaped outer part, in a detailed longitudinal section immediately before the introduction of the inner part which is configured as a hollow rivet and is seated on the widening head of the rivet pin, said constituent parts being shown in the part region which has a rectangular border in FIG. 14,

FIG. 16 shows the hose line, configured as a wound braid hose or double-interlocked hose, from FIGS. 14 and 15 in a following production step, the inner part which is configured as a hollow rivet having already been inserted into the inside hose cross section of the wound braid hose or double-interlocked hose, and the inner part which is configured as a hollow rivet being shown here immediately before pulling through of the rivet pin which is provided for widening the inner part,

FIG. 17 shows the inner part, which is seated on the widening head of the rivet pin, and the outer part of the inner part which is shown here in its non-deformed starting shape, the hose end region of the wound braid hose or double-interlocked hose being arranged between the inner part and the outer part,

FIG. 18 shows the inner part which is introduced into the hose end region of the hose and has already been changed partially there into its widened shape, the hose end region of the flexible hose which is configured here as a double-interlocked hose being supported by way of the sleeve-shaped outer part which engages around it,

FIG. 19 shows the hose connector of the hose line according to FIGS. 14 to 18 in the part region which has a rectangular border in FIG. 18,

FIG. 20 shows the wound braid hose or double-interlocked hose of the hose line which is shown in FIGS. 14 to 19, the rivet pin which is intended to widen the inner part having already been pulled through the inner part of the hose connector,

FIG. 21 shows the hose connector of the hose line which is shown in FIGS. 14 to 20, in the part region, which has a rectangular border in FIG. 20, of the outer part, the inner part, and that hose end region of the wound braid hose or double-interlocked hose which is clamped in between,

FIG. 22 shows a hose line which is shown in a partial longitudinal section and has a hose made from flexible material, the outer part of a hose connector engaging around the illustrated hose end region of the hose, and it being possible for an inner part which is configured as a hollow rivet to be introduced into the inside hose cross section of the hose, which inner part is still seated here in a first production step on the widening head of a rivet pin,

FIG. 23 shows that hose end region of the hose which is engaged around by the outer part of the hose connector, before the inner part which is seated on the widening head of the rivet pin and is still shown here in its non-deformed starting shape is pushed in, the outer part and the inner part including the hose end region being shown here in the part region which has a rectangular border in FIG. 18,

FIG. 24 shows the hose line from FIGS. 22 and 23 after pushing in of the inner part which is seated on the rivet pin into the inside hose cross section of the hose end region which is engaged around by the outer part,

FIG. 25 shows that hose end region of the flexible hose which is engaged around by the sleeve-shaped outer part and into which the hollow rivet which is seated on the rivet pin and serves as an inner part is then inserted, the inner part being shown here in its still non-deformed starting position, and the constituent parts being shown here in the part region which has a rectangular border in FIG. 24,

FIG. 26 shows the hose line from FIGS. 20 to 25 in a further production step during pulling through of the rivet pin through the inner part which is produced from deformable material and is configured as a hollow rivet,

FIG. 27 shows the hose end region, which is engaged around by the sleeve-shaped outer part of the hose connector, and the inner part which has already been deformed partially by the rivet pin here, in the longitudinally sectioned part region which has a rectangular border in FIG. 26,

FIG. 28 shows the hose line from FIGS. 22 to 27 in the finished state, in which the illustrated hose end region of the flexible hose supports the hose connector which is formed from the inner part and the outer part, the rivet pin which is used for widening the inner part having already been pulled through the hollow rivet which serves as inner part,

FIG. 29 shows the hose line from FIGS. 22 to 28 in the part region which has a rectangular border in FIG. 28 and is likewise longitudinally sectioned here, and

FIG. 30 shows a hose line with a flexible hose which supports a hose connector configured in accordance with the previously known prior art at least on its one hose end region.

### DETAILED DESCRIPTION

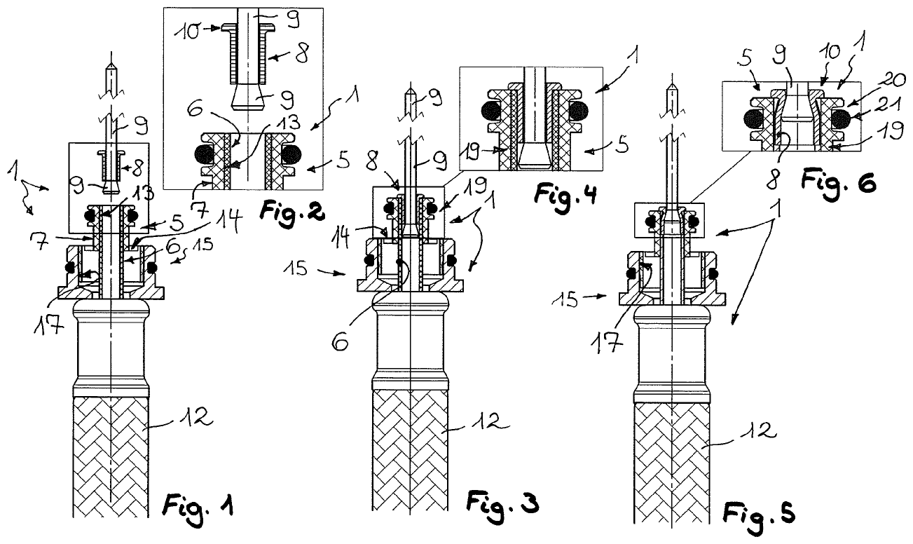

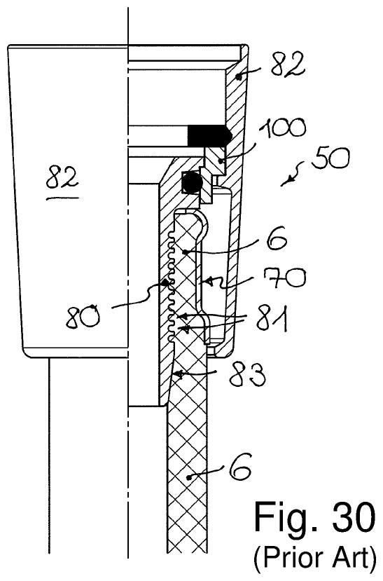

FIGS. 9, 10; 12, 13; 20, 21 and 28, 29 show different embodiments 1, 2, 3 and 4 of a flexible hose line, which embodiments support a hose connector 5 on at least one of its hose end regions. FIGS. 1 to 8, 14 to 19 and 22 to 27 use individual exemplary embodiments to show the production steps which are provided for the production of the hose lines 1, 3 and 4 and for mounting the at least one hose connector 5.

The hose lines 1, 2, 3 and 4 have at least one flexible hose 6 which supports a hose connector 5 on at least one of its two hose end regions. With the aid of the hose connector 5, the fluid guide can be connected upstream or downstream to further line sections and can continue the fluid guidance.

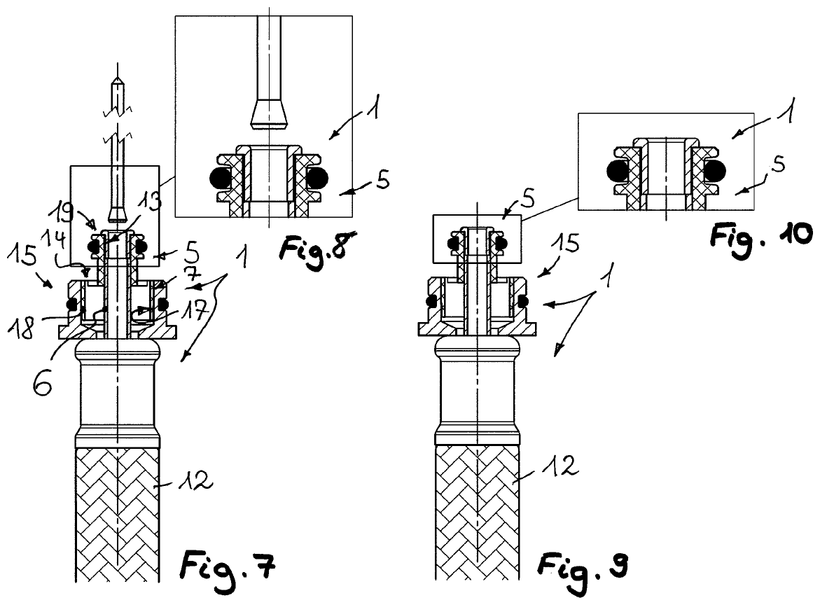

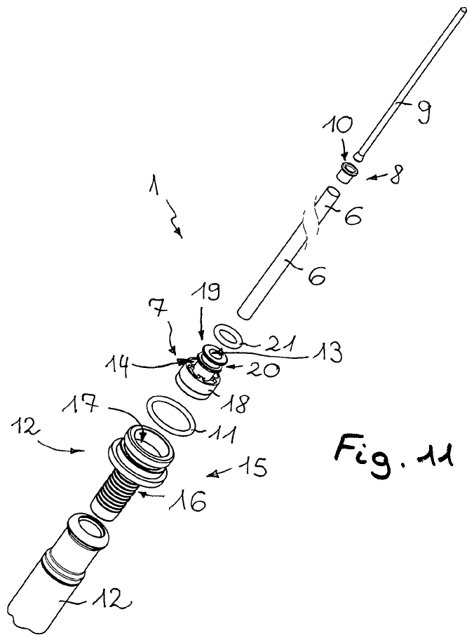

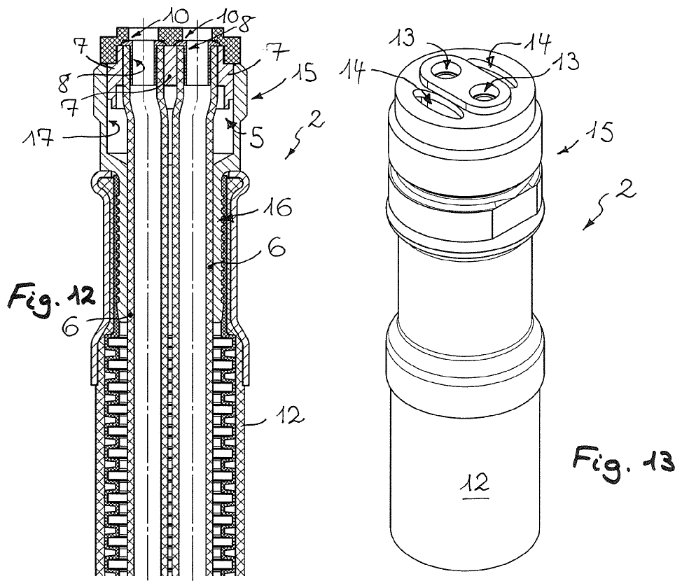

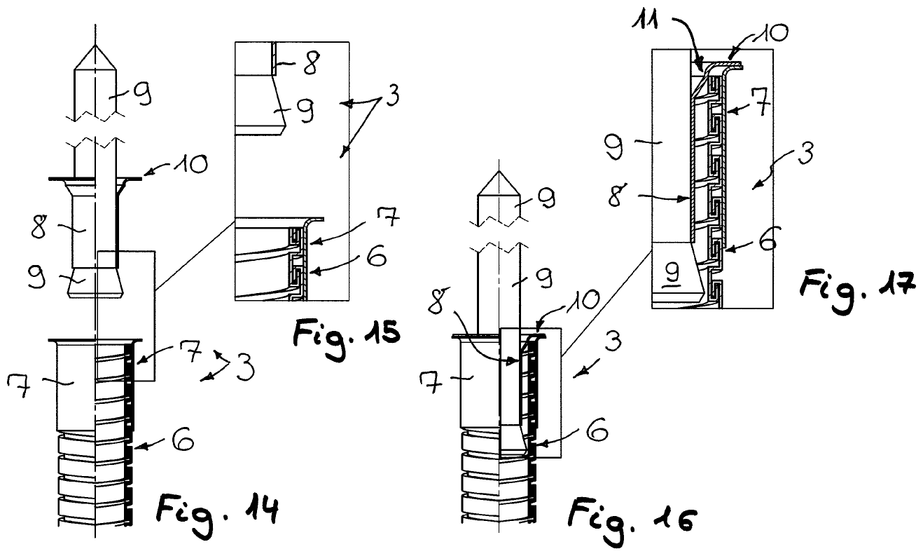

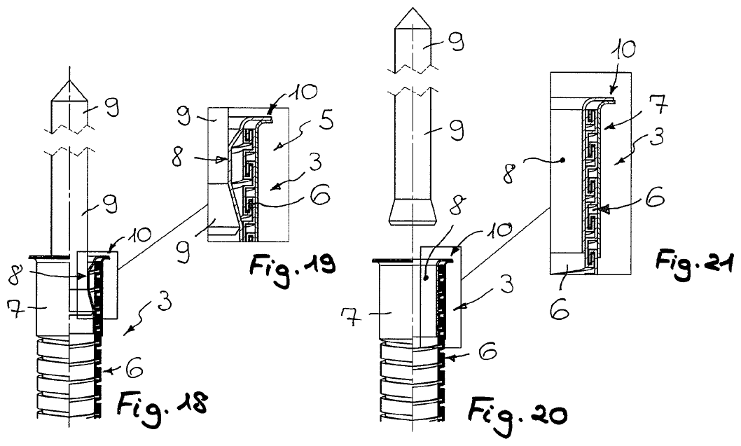

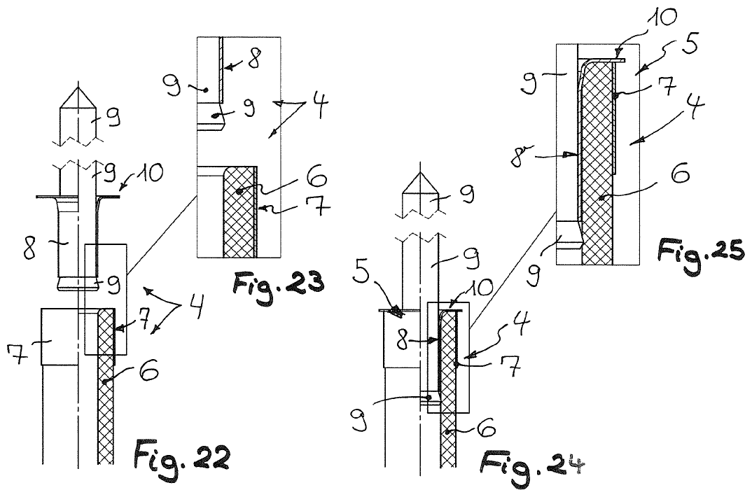

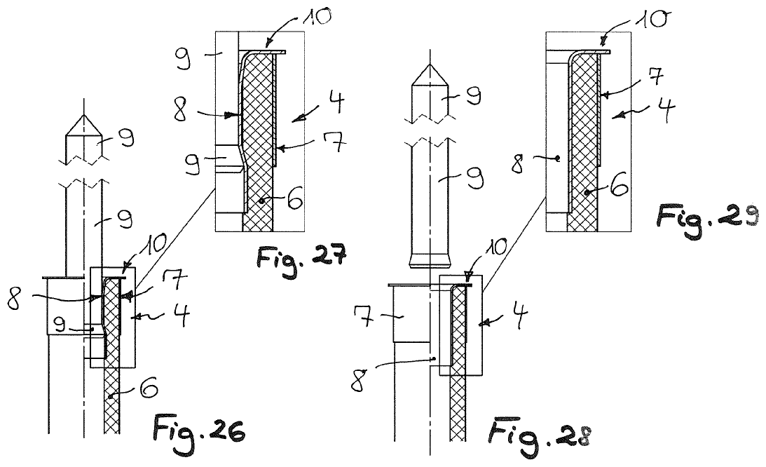

To this end, the hose connector 5 has an outer part 7, which engages around the hose end region of the at least one hose 6, and an inner part 8 which can be introduced into the inside hose cross section of the hose 6. Here, the inner part 8 is configured as a hollow rivet, and can be deformed between a starting shape, which is shown in greater detail in FIGS. 1, 2; 14, 15 and 22, 23 and can be introduced into the inside hose cross section of the hose end region of the hose 6, and a widened shape which is shown in FIGS. 9, 10; 20, 21 and 28, 29. In said widened shape, the at least one hose 6 is clamped in a tight and fixing manner between the inner part 8 and the outer part 7 of the hose connector 5.

Here, the hollow rivet which serves as an inner part 8 is configured as a plunge rivet which can be widened with the aid of the widening head which is provided at the rivet and of a rivet pin 9. Instead of a rivet pin 9 of this type, a widening mandrel (not shown in further detail here) can be used to widen the inner part 8, which widening mandrel possibly also has a plurality of widening parts which can be spread open in the radial direction.

The inner parts 8 of the hose connectors 5 which are provided on the hose lines 1, 2, 3 and 4 in each case have a radially outwardly projecting annular flange 10 which is arranged on that end side of the inner part 8 which projects over the hose end region. In order to aid a tight connecting capability of the hose connector 5 to the adjacent line section of the fluid guide, it can be advantageous if the annular flange 10 of the inner part 8 tapers toward its outer edge and has, in particular, a convexly curved shape on its end side which faces away from the hose end region.

The inner part 8 can be introduced into the inside hose cross section of the hoses 6 which are provided in the hose lines 1, 2, 3, 4, until the annular flange 10 bears against the adjacent end side of the outer part 7.

In order to make controlled widening of the inner part easier and in order to make the widening operation during widening of the inner part 8 increasingly more difficult, it can be advantageous if the inner part 8 has, in its sleeve-shaped part region, a wall thickness which increases in the direction of the end face which faces away from the hose end region, and therefore towards its annular flange 10.

In the widened shape of the inner part 8, the hose end region of the hose 6 is clamped in an immovably fixed and tight manner between the inner part 8 and the outer part 7. In order that the hose end region which is pushed onto the sleeve-shaped part region of the inner part 8 cannot be pulled off again from the hose connector 5 even by way of high axial forces, the inner part 8 which is configured as a hollow rivet supports, on its sleeve-shaped part region, a retaining profiling on the outer circumferential side, which retaining profiling has at least one circumferential retaining groove 11. A plurality of retaining groove 11 which are spaced apart from one another are preferably provided on the sleeve-shaped part region of the inner part 8.

The annular flange 10 which is provided on the inner part 8 can be produced in a simple way as a rim.

FIGS. 1 to 10, 14 to 21 and 22 to 29 show how the hose connector 5 is fixed on the associated hose end region of the hose 6. As becomes clear from FIGS. 1 to 4, 14 to 17 and 22 to 25, the inner part 8 is first of all, in a first method step, inserted into that hose end region of the hose 5 which is engaged around by the outer part 7. By way of pulling of the rivet pin 9 through the inner part 8 which is configured as a hollow rivet and, in particular, as a plunge rivet, the inner part 8 is widened, in at least one following second method step according to FIGS. 5, 6; 18, 19 and 26, 27, in such a way that the hose 5 is clamped in an immovable and tight manner between the inner part 8 and the outer part 7. If the inner part 8 has to be widened to a comparatively great extent, it can be necessary that the hollow rivet which serves as inner part 8 is widened in a plurality of method steps which follow one another in order to clamp the hose 5 between itself and the outer part 7. If a widening mandrel which can be spread open radially in an increasing manner is not used, it can be expedient for a stepped rivet pin 9 or at least one stepped widening mandrel with different widening diameters to be used for the method steps which follow one another. It is also possible for a plurality of stepped or non-stepped widening mandrels with different widening diameters to be used.

It becomes clear from FIGS. 14 to 21 and 22 to 29 that the hose connector 5 which is provided on the hose lines 3, 4 can also serve as a sliding stop for a union nut which engages around the hose end region of the hose 6. Although a union nut of this type is not shown here, it is extremely well known from the prior art which is shown in FIG. 30. To this end, the annular flange 10 projects radially beyond the outer circumference of the hose 6, and can interact with an annular shoulder on the inner circumference of the union nut. The outer part 7 of the hose connector 5 which is provided on the hose lines 3, 4 is configured as a supporting sleeve which encloses the external diameter of the hose 6 tightly in the hose end region.

FIGS. 14 to 21 show that the hose 6 can also be configured as a wound braid hose and, in particular, as what is known as a double-interlocked hose.

In contrast, the hose connector 5 of the hose line 4 is mounted on a hose 6 made from flexible material and, in particular, from flexible plastic material. It can be seen clearly in FIGS. 24 and 25 that the annular flange 10 which projects beyond the external diameter of the hose 6 lies on the adjacent end edge of the outer part 7 and is additionally supported there. In order to aid the secure holding of the hose end region, which is clamped between the inner part 8 and the outer part 7, on the hose connector 5, the inner part 8 which is configured as a hollow rivet is pushed as far as its annular flange 10 into the inside hose cross section of the hose 6 of the hose line 4 in its hose end region.

FIGS. 1 to 13 show that the hose lines 1 and 2 can also be configured as two-chamber or multiple-chamber hose lines. To this end, the hose lines 1, 2 have an outer hose 12, the inside hose cross section of which is penetrated by at least one inner hose 13 or 14. Said outer hose 12 is assigned at least one hose coupling 15 with a hose nipple 16, which hose nipple 16 is engaged around in a tight manner by an associated hose end region of the outer hose 12. The hose coupling 15 with the hose nipple 16 has an end-side receiving cavity 17, in which receiving cavity 17 the hose connector 5 for the at least one inner hose 6 is provided.

The hose connectors 5 which are fixed on the hose lines 1 or 2 have an outer part 7 which can be inserted into the receiving cavity 17, in which outer part at least two holes 13, 14 which penetrate the outer part 7 are provided. The outer part 7 engages around a hose end region of the at least one inner hose 6 at least in one hole 13. An inner part 8, which is also configured here as a hollow rivet, of the hose connector 5 projects into the hose end region of the at least one inner hose 6. Said inner part 8 is widened in such a way that the at least one hose 6 which lies on the inside in the outer hose 12 is clamped in a tight and fixing manner between the inner part, which projects into said inner hose 6, and the outer part 7. It becomes clear from FIGS. 1 to 11 that, in the case of the hose line 1, at least one of the holes 14 in the outer part 7 opens into the hose cavity of the outer hose, which hose cavity is enclosed between the inner circumference of the outer hose 12 and the outer circumference of the at least one inner hose 6. Therefore, two fluid guides which are separate from one another are provided in the hose line 1. Whereas the one first fluid guide is formed by way of the inner hose 6, the hose lumen of the outer hose 12, which hose lumen remains between the inner hose 6 and the inner circumference of the outer sleeve 12, serves as a further second fluid guide.

In contrast, the hose line 2 which is shown in FIGS. 12 and 13 has three fluid guides which are separate from one another. Whereas two fluid guides are formed by way of the inner hoses 6 which are routed through the outer hose 12, a further fluid guide is also provided here which leads through the hose lumen of the outer hose 12, which hose lumen remains between the inner hoses 6 and the inner circumference of the outer hose 12.

In one exemplary embodiment (which is not shown here, however), it is also possible, however, that the hose end region of in each case one inner hose 6 is held in a tight and fixing manner in each of the holes 13, 14 in the outer part 7 of the hose connector 5.

It becomes clear from viewing FIGS. 1 to 11 together that the outer part 7 of the hose connector 5 which is fixed on the hose line 1 has a pot-shaped part region 18 which can be inserted into the receiving cavity 17 of the hose coupling 15, and that a sleeve-shaped part region 19 of reduced cross section projects on the pot bottom of said pot shape, into which sleeve-shaped part region 19 of the outer part 7 the hose end region of the inner hose 6 is clamped in a tight and fixing manner by means of the inner part 8 of the hose connector 5. In order for it also to be possible for the fluid guide which is routed through the inner hose 6 to be connected in a tight manner to adjacent line sections, it can be expedient if the outer part 7 has, at least on its projecting sleeve-shaped part region 19, at least one annular groove 20 for an annular seal 21.

The multiple-chamber hose line 2 which is shown in FIGS. 12 and 13 has three fluid guides which are separate from one another and of which one fluid guide can be used, for example, for hot water, a further fluid guide can be used for sparkling water, and the third fluid guide can be used, for example, for tap water if said multiple-chamber hose line 2 is to be capable of being used, for example, as a kitchen pull-out hose. In order for it to be possible for the hose coupling 15 of the hose line 2 to be connected in a tight manner to adjacent line sections, a shaped or two-hole seal, in particular in accordance with the poka-yoke system, can be provided on the end side of the hose coupling 15.

It can be seen clearly in FIG. 16 and, in particular, also in FIG. 17 that, at least in its non-widened starting shape which is shown here, the inner part 8 can have a widened cross-sectional portion 11 in the inside diameter in the region of the annular flange 10, which widened cross-sectional portion 11 is preferably of open configuration toward that end side of the inner part 8 which supports the annular flange 10. Since the inner part 8 is additionally reinforced and stiffened by way of the annular flange 10 which projects on the outer circumferential side in its end side which supports the annular flange 10, unintentional tearing off of the rivet pin in the region of its rivet head which supports the widening diameter is avoided if the inner part has a widened cross-sectional portion 11 of this type at least in its non-widened starting shape. It is advantageous here if said widened cross-sectional portion is of open configuration toward that end side of the inner part 8 which supports the annular flange 10 and if the widened cross-sectional portion 11 is not followed in the pull-through direction of the rivet pin by any further narrowed cross-sectional portion.

FIG. 30 shows a hose line with a hose connector 50 which belongs to the prior art. The hose line which is shown in FIG. 30 also has a hose made from flexible material with a hose connector 50 which is fixed on at least one of the hose end regions of the flexible hose. Said hose connector 50 has an inner part 80 which can be introduced into the inside hose cross section, is configured as a sleeve-shaped dimensionally stable cast or turned part, and has a retaining profiling consisting of a plurality of circumferential retaining grooves 81 on the outer circumferential side in its part region which is pushed into the hose interior of the flexible hose. That hose end region of the hose which is pushed onto the inner part 80 is fixed with the aid of an outer part 70 which is configured as a crimp sleeve which can be crimped and, in the crimped estate, clamps the hose end region of the flexible hose between itself and the inner part 80. An annular flange 100 is provided on that part region of the inner part 80 which projects beyond the hose end region, which annular flange 100 serves as a sliding stop for a union nut 82, which engages over the hose connector 50 of the previously known hose line, and secures said union nut 82 on the inner part 80. In order for it to be possible for the inner part 80 to be pushed into the hose end region of the flexible hose, the inner part has to have, at its inner part end, an insertion cone 83 which requires a diameter of the inner part 80, which diameter is reduced in comparison with the inside hose diameter of the flexible hose. As a result, however, the inner part 80 projects on the inner circumference of the hose and reduces the free line cross section in said line section. Moreover, the production of the inner part 80 as a turned part and the crimping of the outer part 70 which is configured as a crimp sleeve are associated with not inconsiderable complexity. The construction and production complexity of the hose line which is shown in FIG. 30 and belongs to the prior art is also additionally increased if a hose line of this type is to be configured as a two-chamber hose line or a multiple-chamber hose line which has two or more fluid guides.

In contrast, the hose lines 1, 2, 3 and 4 which are shown in FIGS. 1 to 29 can be produced with considerably lower complexity.

### LIST OF ELEMENT DESIGNATIONS

1 Hose line according to FIGS. 1 to 11

2 Hose line according to FIGS. 12 and 13

3 Hose line according to FIGS. 14 to 21

4 Hose line according to FIGS. 22 to 29

5 Hose connector

6 Hose

7 Outer part

8 Inner part

9 Rivet pin

10 Annular flange

11 Widened cross-sectional portion

12 Outer hose

13 Hole (with inner hose)

14 Hole (in outer part 7)

15 Hose coupling

16 Hose nipple

17 Receiving cavity

18 Pot-shaped part region

19 Sleeve-shaped part region

20 Annular groove

21 Annular seal

50 Hose connector

70 Outer part (in FIG. 30)

80 Inner part (in FIG. 30)

81 Retaining groove

82 Union nut

83 Insertion cone

100 Annular flange

1. A hose connector (5) configured to be fixed on a hose end region of at least one flexible hose (6), the hose connector comprising:
an outer part (7) configured to engage around the hose end region of the at least one hose (6);
an inner part (8) configured to be introduced into an inside hose cross section;
the inner part (8) is configured as a hollow rivet and is deformable from a starting shape, which is introducible into the inside hose cross section of the hose end region, to a widened shape which is adapted to clamp the at least one hose (6) in a tight and fixed manner between the inner part (8) and the outer part (7).

2. The hose connector as claimed in claim 1, wherein the inner part (8) comprises a plunge rivet.

3. The hose connector as claimed in claim 1, wherein the inner part (8) includes an end side which is adapted to project beyond the hose end region that includes a radially outwardly projecting annular flange (10).

4. The hose connector as claimed in claim 3, wherein the annular flange (10) of the inner part (8) tapers toward an outer edge thereof, or the annular flange (10) has a curved shape on the end side which is adapted to face away from the hose end region in an installed position.

5. The hose connector as claimed in claim 3, wherein the inner part (8) is adapted to be introduced into the inside hose cross section until the annular flange (10) bears against an adjacent end face of the outer part (7).

6. The hose connector as claimed in claim 1, wherein the inner part (8) has a sleeve-shaped part region with a wall thickness which increases in a direction toward an end face of the inner part (8) that is adapted to face away from the hose end region.

7. The hose connector as claimed in claim 6, wherein a sleeve-shaped part region of the inner part (8) includes a retaining profiling on an outer circumferential side.

8. The hose connector as claimed in claim 7, wherein the retaining profiling has at least one circumferential retaining groove.

9. The hose connector as claimed in claim 8, wherein the inner part (8) includes a radially outwardly projecting annular flange (10) on an end side which projects is adapted to project beyond the hose end region, and, at least in the starting shape, the inner part (8) has a widened cross-sectional portion (11) in an inside diameter thereof in a region of the annular flange (10), said widened cross-sectional portion (11) has an open configuration toward the end side with the annular flange (10).

10. A hose line (3, 4) comprising the hose connector (5) as claimed in claim 3 at least at one line end of the hose line, wherein the annular flange (10) of the inner part (8) projects beyond an outer circumference of the outer part (7), a union nut is engaged around the outer part (7) the inner part (8) secures the union nut on the outer part (7), and an annular zone of the annular flange (10) which projects beyond the outer circumference of the outer part (7) provides a sliding stop for the union nut which is retained on the outer part.

11. The hose line as claimed in claim 10, wherein the outer part (7) comprises a supporting sleeve.

12. The hose line as claimed in claim 10, wherein the annular flange (10) comprises a rim on the inner part (8).

13. The hose line as claimed in claim 10, wherein the hose is comprised of a resiliently flexible material.

14. The hose line as claimed in claim 10, wherein the hose includes a braid.

15. The hose line (2) as claimed in claim 10, wherein the hose comprises a wound braid hose.

16. The hose line as claimed in claim 15, wherein the wound braid hose encases at least one hose layer or at least one inner hose (6).

17. The hose line as claimed in claim 16, wherein the inner part (8) clamps the wound braid hose on one side and the encasing hose layer or the at least one inner hose (6) on the other side between itself and the outer part (7).

18. A hose line (1, 2) which is configured as a two-chamber or multiple-chamber hose line, comprising:
at least one inner hose,
an outer hose (12) having an inside hose cross section that is penetrated by the at least one inner hose (6),
at least one hose coupling (15) with a hose nipple (16) on the outer hose, the hose nipple (16) being engaged around by an associated hose end region of the outer hose (12),
the hose coupling (15) has an end-side receiving cavity (17), in which a hose connector (5) as claimed in claim 1 is provided for the at least one inner hose (6), the hose connector (5), the outer part (7) of the hose connector (5) is inserted into the receiving cavity (17) of the hose coupling (15), at least two holes (13, 14) penetrate the outer part (7) the outer part (7) engages around a hose end region of the at least one inner hose (6) at least in one of the holes (13), and the inner part (8) of the hose connector (5) projects into a hose end region of the at least one inner hose (6), with the inner part (8) being widened such that the inner hose (6) is clamped in between the inner part (8), which projects into said inner hose (6), and the outer part (7).

19. The hose line as claimed in claim 18, wherein at least one of the holes (14) in the outer part (7) opens into a hose cavity of the outer hose (12) which is enclosed between an inner circumference of the outer hose (12) and an outer circumference of the at least one inner hose (6).

20. The hose line as claimed in claim 18, wherein the hose end region of in each case one said inner hose (6) is retained in each of the holes (13) in the outer part (8) of the hose connector (5).

21. The hose line as claimed in claim 18, wherein the outer part (7) has a pot-shaped part region (18) that is inserted into the receiving cavity (17) of the hose coupling (15), and a sleeve-shaped part region (19) of reduced cross section projects on a pot bottom of said pot-shaped part region (18), into which sleeve-shaped part region (19) of the outer part (7) the hose end region of the inner hose (6) is clamped by the inner part (8) of the hose connector (5).

22. The hose line as claimed in claim 21, further comprising at least one annular groove (20) for an annular seal (21) located, at least on the projecting sleeve-shaped part region (19).

23. A method for producing a hose connector for a hose end region of a flexible hose (6), the method comprising:
providing an outer part (7), which engages around the hose in the hose end region, and providing an inner part (8) made from deformable material, the inner part (8) comprising a hollow rivet,
inserting the inner part into the hose end region of the hose (6) which is engaged around by the outer part (7), and
widening the inner part (8) such that the hose (6) is clamped in between the inner part (8) and the outer part (7).

24. The method as claimed in claim 23, further comprising using a rivet pin (9) or an expanding mandrel to widen the inner part (8) comprising the hollow rivet.

25. The method as claimed in claim 24, wherein the hollow rivet is widened in a plurality of steps which follow one another in order to clamp the hose (6) between the hollow rivet and the outer part (7).

26. The method as claimed in claim 25, wherein the method steps which follow one another include using at least two rivet pins (9) or expanding mandrels with different widening diameters.
